(19) United States
(12) Patent Application Publication
(10) Pub. No.: US 2021/0123152 A1
(43) Pub. Date: Apr. 29, 2021

(54) Method for Preparing Large-area Catalyst Electrode

(71) Applicant: National Chung-Shan Institute of Science and Technology, Taoyuan City (TW)

(72) Inventors: Kuan-Ting Lai, Taoyuan City (TW); Chung-Yen Lu, Taoyuan City (TW); Chia-Kan Hao, Taoyuan City (TW)

(21) Appl. No.: 17/076,815

(22) Filed: Oct. 22, 2020

(30) Foreign Application Priority Data
Oct. 23, 2019 (TW) 108138531

(51) Int. Cl. C25D 13/02; C25D 13/12; C25B 11/04; C25B 1/04

(52) U.S. Cl. CPC C25D 13/02; C25D 13/12; C25B 11/0478; C25B 1/04; C25B 11/0405

(57) ABSTRACT

A method for preparing a large-area catalyst electrode includes the following steps: (A) providing an iron compound, a cobalt compound and a nickel compound, and dissolving these metal compounds in a solvent to form a mixed metal compound solution, and (B) providing a cathode and an anode, and performing a cathodic electrochemical deposition to the cathode, the anode and the mixed metal compound solution in a condition of constant voltage or constant current through a two-electrode method, followed by obtaining a catalyst electrode from the cathode. In the method for preparing the large-area catalyst electrode of the present invention, the large-area catalyst electrode having good dual-function water electrolysis catalytic property can be prepared by the steps of preparing the electrolyte, the electrochemical deposition, and the like. The process is simple and energy-saving.

### BACKGROUND OF THE INVENTION

### 1. Field of the Invention

The present invention relates to a method for preparing a catalyst electrode, and more particularly to a method for preparing a large-area catalyst electrode.

### 2. Description of the Prior Art

The carbon dioxide emitted by the extensive use of fossil fuels is one of the main reasons of global warming. The product after the combustion of hydrogen is water only, and there is no carbon dioxide emission problem. Therefore, hydrogen is a clean energy, which can replace the traditional fossil fuels. Hydrogen has a high energy density per unit and a wide range of applications, which can be used in the chemical industry, energy storage, fuel cells, and the like.

The method for preparing hydrogen mainly includes hydrogen production by fossil fuels, water electrolysis method, industrial residual hydrogen, biological method, and the like. The hydrogen production by fossil fuels would generate a large amount of carbon dioxide. The water electrolysis method is a method for preparing hydrogen with zero emission of carbon dioxide. However, because the power consumption is high and noble metals are traditionally used as the catalyst in the water electrolysis method, the cost for producing hydrogen becomes high. Due to cost considerations, currently more than 95% of the hydrogen sources in the world are produced from coal, natural gas or petroleum as raw materials, and the remaining 4% is produced through electrolysis.

In the process of electrolysis of water, the electrolytic cell is composed of three parts including an electrolyte, a cathode and an anode. A hydrogen evolution catalyst (HEC) and an oxygen evolution catalyst (OEC) are respectively coated on the cathode and the anode to accelerate the water spitting reaction. When a voltage is applied to the electrode, the electrolysis of water may be divided into two half reactions. One of the half reactions is the hydrogen evolution reaction (HER) in which the water molecules are reduced to produce hydrogen at the cathode, and the another one of the half reactions is the oxygen evolution reaction (OER) in which the water molecules are oxidized to produce oxygen at the anode. The thermodynamic voltage of electrolysis of water to produce hydrogen at an atmospheric pressure and 25° C. is 1.23V. However, the actual voltage Eₒₚ applied in the electrolysis of water is equal to the sum of 1.23V, ηₐ, η_{c} and ηₒₜₕₑᵣ (Eₒₚ=1.23V+ηₐ+η_{c}+ηₒₜₕₑᵣ). Therefore, it can be seen from the above equation that the additional applied voltage is the overpotential η, and the affecting factors mainly include the material of the electrode, the effective active area of the electrode and the formation of bubbles.

In the process of electrolysis of water, the anodic oxygen evolution reaction involves the transfer of four electrons, so the dynamics of the anodic reaction is slow, thereby causing excessive power consumption due to the high overpotential, which is a key factor that restricts the development of water electrolysis technique. The best HER/OER catalyst now is the noble metal Pt/IrO₂ or Pt/RuO₂, which has high corrosion resistance in acid electrolytes or alkaline electrolytes and exhibits good catalytic activity (having lower overpotential and lower Tafel slope). However, due to the low contents on earth and high prices of the noble metals, the cost of electrolysis of water to produce hydrogen is excessive high, such that it cannot be widely applied. Therefore, to form the composite metal catalyst having lower price, high activity and high stability by using metals such as iron (Fe), cobalt (Co), nickel (Ni), copper (Cu), molybdenum (Mo) and tungsten (W), which are abundant on earth, have become an important and urgent research direction in recent years.

Experts and scholars from various countries are committed to the development of highly active hydrogen and oxygen evolution water electrolysis catalysts, and the optimized preparation method of the electrode is adopted to reduce the overpotential of the water splitting reaction. In recent years, research reports have indicated that alloys, oxides, sulfides, nitrides, phosphides, carbides and borides of the transition metals and the non-metallic composite materials can be used as heterogeneous catalysts in the water phase for electrolysis of water to produce hydrogen. Transition metal oxides/hydroxides and transition metal sulfides can be used as heterogeneous catalysts for electrolysis of water to produce oxygen. For example, a Fe-doped Ni₃S₂ thin film catalyst prepared on Ni foam through the hydrothermal synthesis is published by Sun's team, wherein the catalyst exhibits good electrocatalytic oxygen evolution activity under 1M potassium hydroxide alkaline aqueous solution, and a high current density of 100 mA/cm² can be achieved by only a low overpotential of 257 mV; and a NiFeS needle-like film synthesized on Ni foam through the two-step method (electrochemical deposition and hydrothermal synthesis) is published by Liu's team, and can be served as the high-effective heterogeneous catalyst for alkaline aqueous solution electrolysis of water to produce oxygen. However, in the methods for preparing the water electrolysis catalysts mentioned above, the processes require high temperature and are time-consuming, such that it is difficult to control the cost. Therefore, industrial mass production cannot be achieved.

Accordingly, a method for preparing a large-area catalyst electrode is required by the industry now, in which the non-noble metals having lower costs can be served as raw materials, and the simple, energy-saving and time-saving two-electrode method can be used to perform the cathodic electrochemical deposition process to prepare the large-area catalyst electrode that meets the demands of the industry.

### SUMMARY OF THE INVENTION

According to the disadvantages of the prior arts mentioned above, the main purpose of the present invention is to provide a method for preparing a large-area catalyst electrode including the steps of preparing the electrolyte and the electrochemical deposition, so as to prepare the large-area catalyst electrode having good dual-function water electrolysis catalytic properties.

In the cathodic electrochemical deposition adopted by the present invention, the cathodic electrodeposition is performed to the mixed solution containing the metal raw materials through the two-electrode method in a condition of constant voltage or constant current provided by the direct current stabilized power supply, wherein the cathode is the working electrode, and the anode is the auxiliary electrode, such that a thin layer of the catalyst can be formed on the surface of the cathode, and the process is fast. In addition, the large-area catalyst electrode can be directly prepared by the solid state hydrogen/oxygen evolution catalyst of the present invention through a one-step method, such that process for manufacturing the catalyst electrodes can be economically improved. The large-area catalyst electrode can be used to increase the amount of hydrogen and oxygen produced by alkaline water electrolysis, and can be introduced to the large-scale industrial electrolysis of water to produce hydrogen, so as to enhance industrial competitiveness.

In order to achieve the above-mentioned goals, a method for preparing a large-area catalyst electrode is provided according to one of the solutions of the present invention. The method for preparing the large-area catalyst electrode of the present invention includes: (A) providing an iron compound, a cobalt compound and a nickel compound, and dissolving these metal compounds in a solvent to form a mixed metal compound solution, and (B) providing a cathode and an anode, and performing the cathodic electrochemical deposition to the cathode, the anode and the mixed metal compound solution in a condition of constant voltage or constant current through a two-electrode method, followed by obtaining a catalyst electrode from the cathode.

In the step (A) mentioned above, the iron compound can be ammonium iron sulfate, iron chloride, iron nitrate, iron sulfate or iron-containing coordination compound, the cobalt compound can be cobalt chloride, cobalt nitrate, cobalt sulfate or cobalt-containing coordination compound, and the nickel compound can be nickel chloride, nickel nitrate, nickel sulfate or nickel-containing coordination compound. The material of the cathode or the anode can be selected from graphite, nickel, copper or stainless steel, and an area of the anode is greater than or equal to an area of the cathode. The structure of the cathode or the anode is selected from foam, plate or mesh. The solvent is selected from water, methanol, ethanol, isopropanol, 1-butanol, acetone solution or combinations thereof. The concentration of the iron compound, the cobalt compound or the nickel compound in the solvent may range from 0.01M to 0.5M.

Before the step (B) mentioned above, the following step may be further included: the cathode and the anode are pretreated with hydrochloric acid and alcohol to remove oxides and surface impurities.

In the step (B) mentioned above, the constant current can range from 0.1 A to 1 A, the constant voltage can range from 0.1V to 1V, and a electrochemical deposition time can range from 1 min to 20 min.

In the present invention, the method for preparing the large-area catalyst electrode is provided, and the feature of this method is that the non-noble metal raw materials having low costs are adopted, wherein the iron-containing compound, the nickel-containing compound and the cobalt-containing compound are mixed to form the mixed metal aqueous solution, and a large-area cathodic electrochemical deposition can be performed to the mixed metal aqueous solution through the two-electrode method in a condition of constant current or constant voltage, such that a thin layer of the catalyst electrode can be formed on the surface of the electrode plate, and the catalyst electrode can have large specific surface area. The large-area catalyst electrode can be formed in only one step, which means that the process is simple and energy saving.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a flow chart of a method for preparing a large-area catalyst electrode according to the present invention.

FIG. 2 schematically illustrates a cathode and an anode after the electrochemical deposition according to an embodiment of the present invention.

FIG. 3 schematically illustrates a cathodic catalyst electrode and an anodic catalyst electrode of a catalyst electrode after electrochemical electrolysis of water according to an embodiment of the present invention.

FIG. 4 is a scanning electron microscope diagram of the cathodic catalyst electrode of the catalyst electrode after electrochemical electrolysis of water according to an embodiment of the present invention.

FIG. 5 is an energy dispersive X-ray spectroscopy diagram of the cathodic catalyst electrode of the catalyst electrode after electrochemical electrolysis of water according to an embodiment of the present invention.

FIG. 6 is a scanning electron microscope diagram of the anodic catalyst electrode of the catalyst electrode after electrochemical electrolysis of water according to an embodiment of the present invention.

FIG. 7 is an energy dispersive X-ray spectroscopy diagram of the anodic catalyst electrode of the catalyst electrode after electrochemical electrolysis of water according to an embodiment of the present invention.

### DETAILED DESCRIPTION

The implementation methods of the present invention will be described by the specific embodiment in the following contents. It should be noted that for those of ordinary skill in the art, the advantages and effects of the present invention can be easily understood after reading the disclosed contents of the present specification.

In a method for preparing a large-area catalyst electrode according to the present invention, a cathodic electrochemical deposition is adopted, in which a cathodic electrodeposition is performed to a mixed solution containing metal raw materials through the two-electrode method in a condition of constant voltage or constant current provided by the direct current stabilized power supply, such that a uniform thin layer of the catalyst electrode can be formed on the surface of the cathode. That is, the dual-function water electrolysis catalyst electrode can be prepared in only one step. The catalyst electrode prepared by the present invention can exhibit dual-function catalytic activity of hydrogen evolution and oxygen evolution through an electrochemical test under a 1M KOH alkaline condition.

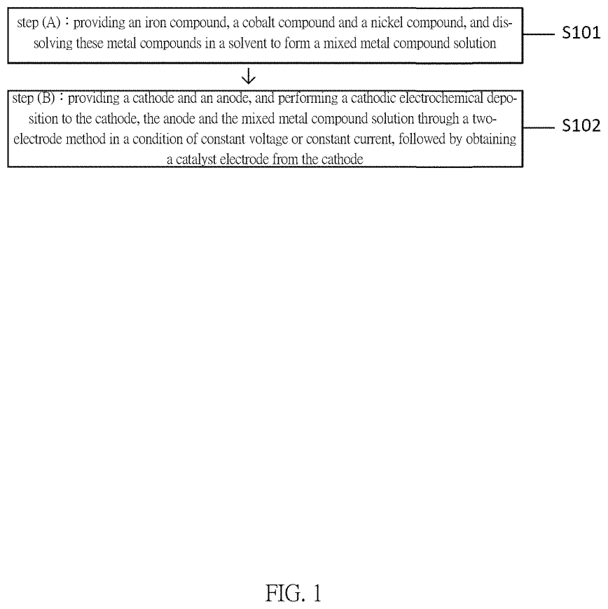

Referring to FIG. 1, FIG. 1 schematically illustrates a flow chart of a method for preparing a large-area catalyst electrode according to the present invention. As shown in FIG. 1, a method for preparing a large-area catalyst electrode according to the present invention includes: (A) providing an iron compound, a cobalt compound and a nickel compound, and dissolving the above-mentioned metal compounds in a solvent to form a mixed metal compound solution 5101, and (B) providing a cathode and an anode, and performing a cathodic electrochemical deposition to the cathode, the anode and the mixed metal compound solution through the two-electrode method in a condition of constant voltage or constant current, followed by taking the cathode to obtain a catalyst electrode 5102, i.e., obtaining a catalyst electrode 5102 by taking the cathode.

The iron compound may be selected from ammonium iron sulfate, iron chloride, iron nitrate, iron sulfate or iron-containing coordination compound, the cobalt compound may be selected from cobalt chloride, cobalt nitrate, cobalt sulfate or cobalt-containing coordination compound, and the nickel compound may be selected from nickel chloride, nickel nitrate, nickel sulfate or nickel-containing coordination compound. The cathode or the anode is selected from graphite, nickel, copper or stainless steel, and an area of the anode is greater than or equal to an area of the cathode. The solvent may be selected from water, methanol, ethanol, isopropanol, 1-butanol, acetone solution or combinations thereof.

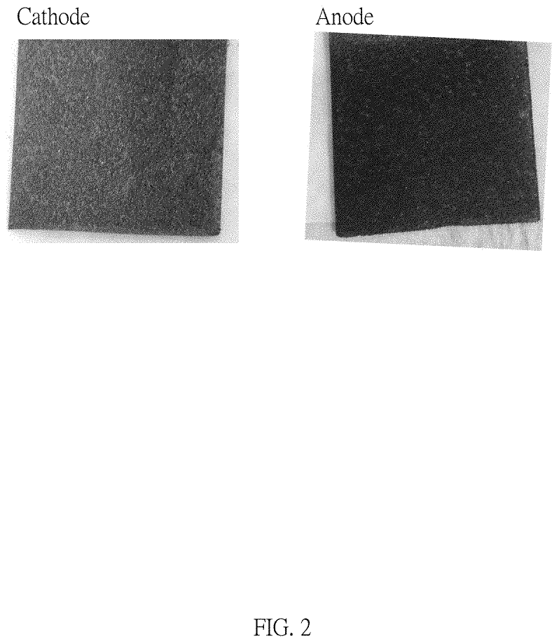

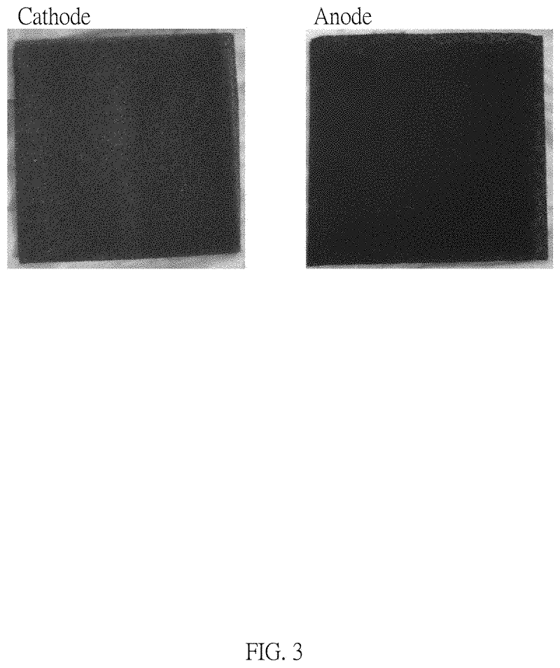

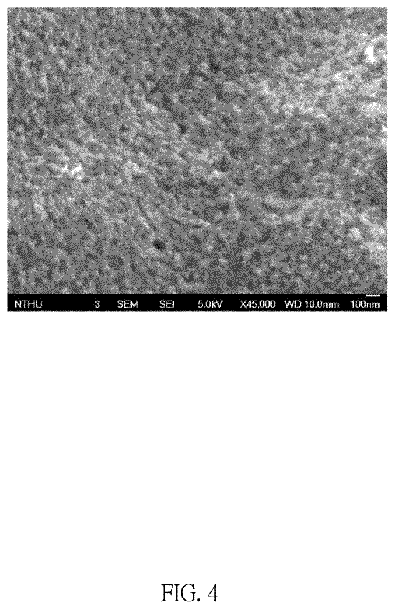

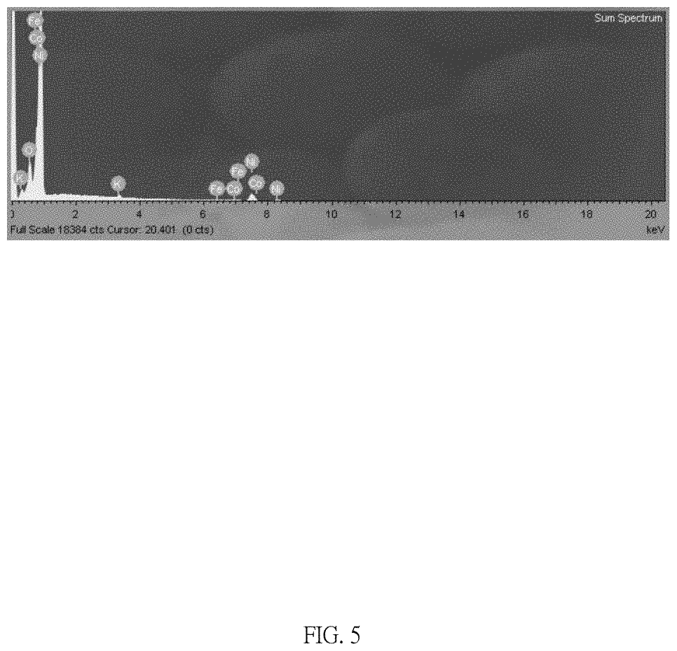

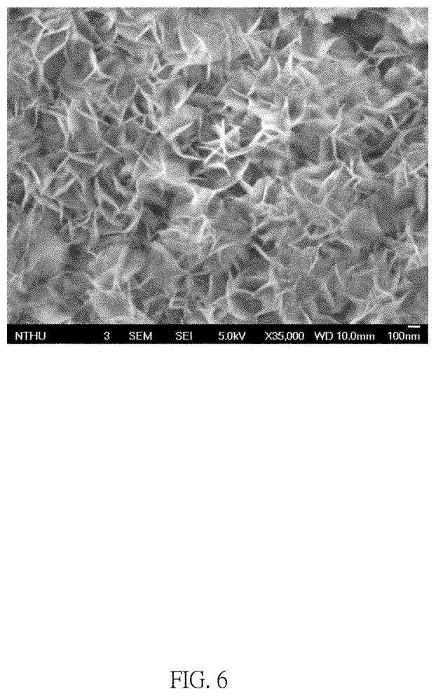

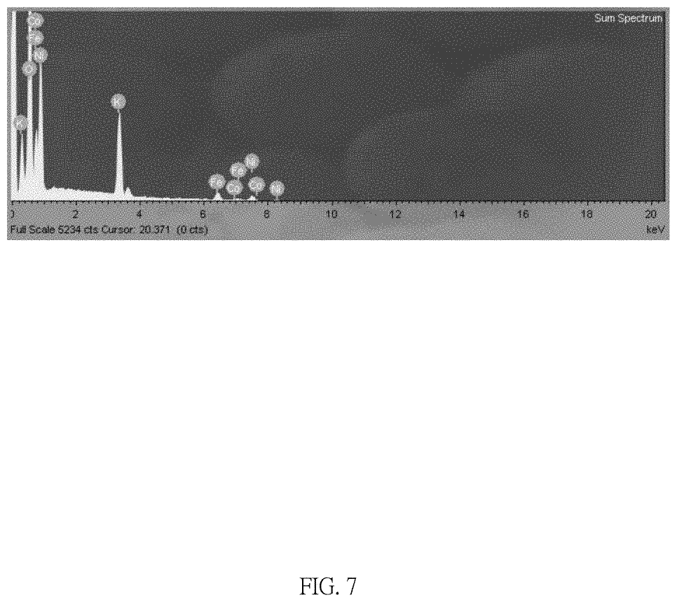

Example 1: A 0.05M FeCl₃ aqueous solution, a 0.05M FeSO₄ aqueous solution, a 0.1M Co(NO₃)₂ aqueous solution and a 0.1M Ni(NO₃)₂ aqueous solution are respectively prepared, and the above-mentioned metal compound solution are mixed by stirring, followed by performing the cathodic electrodeposition experiment through the two-electrode system, wherein the working electrode and the auxiliary electrode are both Ni foam (5 cm*5 cm), a constant current of 0.2 A is applied, the deposition time is 10 min, and an oxygen evolution catalyst electrode (as shown in FIG. 2) having an area of 25 cm² is formed. After that, a catalyst electrode with a small area (0.08 cm²) is cut out of the prepared large-area catalyst electrode (25 cm²) for catalytic activity measurement of hydrogen/oxygen evolution reactions (HER/OER), in which the catalyst electrode with the small area is put in aqueous solution of 1M KOH electrolyte, and a linear sweep voltammetry (LSV) test of the electrochemistry is performed. It is found that the deposited thin film has the catalytic activities for the hydrogen evolution reaction and the oxygen evolution reaction, and the release of gas on the surface of the electrode plate is also observed during the process. It can be seen from the experimental data of the hydrogen evolution reaction that the overpotential η is 181 mV when the current density reaches 100 mA/cm², and it can be seen from the experimental data of the oxygen evolution reaction that the overpotential η is 259 mV when the current density reaches 100 mA/cm². Referring to FIG. 2, FIG. 2 schematically illustrates a cathode and an anode after the electrochemical deposition according to an embodiment of the present invention. Referring to FIG. 3, FIG. 3 schematically illustrates a cathodic catalyst electrode and an anodic catalyst electrode of a catalyst electrode after electrochemical electrolysis of water according to an embodiment of the present invention. Referring to FIG. 4, FIG. 4 is a scanning electron microscope diagram of the cathodic catalyst electrode of the catalyst electrode after electrochemical electrolysis of water according to an embodiment of the present invention. As shown in FIG. 4, the cathodic catalyst after electrochemical electrolysis of water presents a sub-micron plate shape. Referring to FIG. 5, FIG. 5 is an energy dispersive X-ray spectroscopy diagram of the cathodic catalyst electrode of the catalyst electrode after electrochemical electrolysis of water according to an embodiment of the present invention. As shown in FIG. 5, the cathodic catalyst electrode after electrochemical electrolysis of water contains three metal elements including iron, cobalt and nickel. Referring to FIG. 6, FIG. 6 is a scanning electron microscope diagram of the anodic catalyst electrode of the catalyst electrode after electrochemical electrolysis of water according to an embodiment of the present invention. As shown in FIG. 6, the anodic catalyst after electrochemical electrolysis of water presents a micron plate shape. Referring to FIG. 7, FIG. 7 is an energy dispersive X-ray spectroscopy diagram of the anodic catalyst electrode of the catalyst electrode after electrochemical electrolysis of water according to an embodiment of the present invention. As shown in FIG. 7, the anodic catalyst electrode after electrochemical electrolysis of water contains three metal elements including iron, cobalt and nickel.

Example 2: A 0.075M FeCl₃ aqueous solution, a 0.025M FeSO₄ aqueous solution, a 0.1M Co(NO₃)₂ aqueous solution and a 0.1M NiSO₄ aqueous solution are respectively prepared, and the above-mentioned metal compound solution are mixed by stirring, followed by performing the cathodic electrodeposition experiment through the two-electrode system, wherein the working electrode and the auxiliary electrode are both Ti mesh (5 cm*5 cm), a constant current of 0.6 A is applied, the deposition time is 5 min, and an oxygen evolution catalyst electrode having an area of 25 cm² is formed. After that, a catalyst electrode with a small area (0.08 cm²) is cut out of the prepared large-area catalyst electrode (25 cm²) for catalytic activity measurement of the hydrogen/oxygen evolution reaction (HER/OER), in which the catalyst electrode with the small area is put in aqueous solution of 1M KOH electrolyte, and a LSV test of the electrochemistry is performed. It is found that the deposited thin film has the catalytic activities of the hydrogen evolution reaction and the oxygen evolution reaction, and the release of gas on the surface of the electrode plate is also observed during the process. It can be seen from the experimental data of the hydrogen evolution reaction that the overpotential η is 169 mV when the current density reaches 100 mA/cm², and it can be seen from the experimental data of the oxygen evolution reaction that the overpotential η is 243 mV when the current density reaches 100 mA/cm².

Compared with the high-temperature and high-pressure method in the prior art literature, the non-noble metals having low costs are adopted as the raw materials in the preparing method of the present invention, and the traditional noble metal catalysts for electrolysis of water are replaced. The mixed metal solution is prepared, and the large-area cathodic electrochemical deposition is performed through the two-electrode method in a condition of constant current or constant voltage, such that a uniform thin film of the catalyst can be formed on the surface of the electrode plate. In the method of the present invention, the processes of mixing the raw materials and the electrochemical deposition are fast, the equipment is simple, and the large-area catalyst electrode applied to electrolysis of water for hydrogen evolution and oxygen evolution under an alkaline condition can be mass produced in only one step. In addition, the catalyst electrode prepared by the present invention can contain three metal elements including iron, cobalt and nickel, which can help the subsequent water electrolysis process to have dual-function hydrogen evolution and oxygen evolution effect, and the efficiency of water electrolysis and the amount of gas produced can be effectively improved. Therefore, in the preparation method of the present invention, the process is simple, the strict conditions such as high temperature, high pressure and high specification equipment are not required, the production cost is low, and the economic and energy-saving benefits are included.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for preparing a large-area catalyst electrode, comprising following steps:
(A) providing an iron compound, a cobalt compound and a nickel compound, and dissolving the iron compound, the cobalt compound and the nickel compound in a solvent to form a mixed metal compound solution, and
(B) providing a cathode and an anode, and performing a cathodic electrochemical deposition to the cathode, the anode and the mixed metal compound solution through a two-electrode method in a condition of constant voltage or constant current, followed by obtaining a catalyst electrode from the cathode.

2. The method for preparing the large-area catalyst electrode of claim 1, wherein the iron compound is ammonium iron sulfate, iron chloride, iron nitrate, iron sulfate or iron-containing coordination compound.

3. The method for preparing the large-area catalyst electrode of claim 1, wherein the cobalt compound is cobalt chloride, cobalt nitrate, cobalt sulfate or cobalt-containing coordination compound.

4. The method for preparing the large-area catalyst electrode of claim 1, wherein the nickel compound is nickel chloride, nickel nitrate, nickel sulfate or nickel-containing coordination compound.

5. The method for preparing the large-area catalyst electrode of claim 1, wherein the solvent is selected from water, methanol, ethanol, isopropanol, 1-butanol, acetone solution or combinations thereof.

6. The method for preparing the large-area catalyst electrode of claim 1, wherein a material of the cathode or the anode is selected from graphite, nickel, copper or stainless steel, and an area of the anode is greater than or equal to an area of the cathode.

7. The method for preparing the large-area catalyst electrode of claim 1, wherein a structure of the cathode or the anode is foam, plate or mesh.

8. The method for preparing the large-area catalyst electrode of claim 1, wherein a concentration of the iron compound, the cobalt compound or the nickel compound ranges from 0.01M to 0.5M.

9. The method for preparing the large-area catalyst electrode of claim 1, wherein the constant current ranges from 0.1 A to 1 A, and an electrochemical deposition time ranges from 1 min to 20 min in the step (B).

10. The method for preparing the large-area catalyst electrode of claim 1, wherein the constant voltage ranges from 0.1V to 1V and an electrochemical deposition time ranges from 1 min to 20 min in the step (B).
